(19) United States
(12) Patent Application Publication
(10) Pub. No.: US 2026/0016094 A1
(43) Pub. Date: Jan. 15, 2026

(54) APPARATUS TO PREVENT FUGITIVE EMISSIONS IN ROTARY VALVES

(71) Applicant: Emerson Process Management (Tianjin) Valves Co., LTD., Tianjin (CN)

(72) Inventor: Sharon Zhang, Tianjin (CN)

(21) Appl. No.: 19/182,876

(22) Filed: Apr. 18, 2025

(30) Foreign Application Priority Data
Jul. 11, 2024 (CN) 202410930915.6

(51) Int. Cl. F16K 5/04

(52) U.S. Cl. CPC F16K 5/0485; F16K 5/045

(57) ABSTRACT

Apparatus to prevent fugitive emissions in rotary valves are disclosed herein. An example apparatus includes a rotary valve including a valve body, a flow control member, and a valve shaft coupled to the flow control member. The apparatus also includes an actuator including a rod that is movable in a linear direction, and a mounting housing coupled between the rotary valve and the actuator. The valve shaft and the rod extend into the mounting housing. The apparatus includes a linkage to convert linear motion of the rod to rotary motion of the valve shaft. The apparatus system also includes a bellows disposed around a portion of the rod in the mounting housing. The bellows is coupled to the rod and the mounting housing to prevent fugitive emissions from the mounting housing.

### RELATED APPLICATION

This patent claims the benefit of Chinese Patent Application No. 202410930915.6, which was filed on Jul. 11, 2024. Chinese Patent Application No. 202410930915.6 is hereby incorporated herein by reference in its entirety. Priority to Chinese Patent Application No. 202410930915.6 is hereby claimed.

### FIELD OF THE DISCLOSURE

This disclosure relates generally to rotary valves and, more particularly, apparatus to prevent fugitive emissions in rotary valves.

### BACKGROUND

Control valves are commonly distributed throughout process control systems to control the flow of various fluids (e.g., liquids, gases, etc.). Control valves can vary in size and operating conditions (e.g., operating pressures, operating temperatures, operating fluids, etc.). Control valves are often operated by movement of a shaft or stem that extends through a channel in the valve body. Valve packing is used to seal the opening surrounding the shaft or stem to prevent fluid leakage from the channel.

### SUMMARY

An example apparatus disclosed herein includes a rotary valve including a valve body defining a fluid passageway, a flow control member in the fluid passageway, and a valve shaft coupled to the flow control member. The valve shaft extends through a shaft channel defined in the valve body. The apparatus includes an actuator including a rod that is movable in a linear direction. The apparatus includes a mounting housing coupled between the rotary valve and the actuator. The valve shaft extends into the mounting housing, and the rod extends into the mounting housing. The apparatus also includes a linkage in the mounting housing coupled between the valve shaft and the rod. The linkage is to convert linear motion of the rod to rotary motion of the valve shaft. The apparatus further includes a bellows disposed around a portion of the rod in the mounting housing. The bellows is coupled to the rod and the mounting housing to prevent fugitive emissions from the mounting housing.

An example apparatus disclosed herein includes an actuator having a rod that is movable in a linear direction and a mounting housing having a first flange portion with a first opening and a second flange portion with a second opening. The first flange is portion to be coupled to a rotary valve. The second flange portion is coupled to the actuator with the rod of the actuator extending through the second opening and into the mounting housing. The apparatus also includes a linkage in the mounting housing. The rod is coupled to the linkage. The linkage is to convert linear motion of the rod to rotary motion of a valve shaft. The apparatus further includes a bellows disposed around a portion of the rod in the mounting housing. A first end of the bellows coupled to the rod and a second end of the bellows coupled to the mounting housing to prevent fugitive emissions at an interface of the mounting housing and the actuator.

### BRIEF DESCRIPTION OF THE DRAWINGS

FIG. 1 is a perspective view of an example control valve system including an example rotary valve, an example actuator, and an example mounting housing.

FIG. 2 is a cross-sectional view of the example control valve system taken along line A-A of FIG. 1 showing an example interior region of the example mounting housing.

FIG. 3 is a perspective view showing inside the example mounting housing.

FIG. 4 is a cross-sectional view of the example control valve system taken along line B-B of FIG. 1.

FIG. 5 shows an example of welding the example mounting housing to the example rotary valve.

The figures are not necessarily to scale. Instead, the thickness of the layers or regions may be enlarged in the drawings. In general, the same reference numbers will be used throughout the drawing(s) and accompanying written description to refer to the same or like parts.

### DETAILED DESCRIPTION

Emissions from valves and other process control devices due to insufficient sealing can be an issue for end users, such as operators of oil and gas refineries, chemical and petrochemical plants, as well as regulators across the globe. The Environmental, Social, and Governance (ESG) movement has gained traction in recent years, with many companies engaging in ESG improvements. Fugitive emissions refers to the unintentional and undesirable emission, leakage, or discharge of gases/vapors from pressure-containing equipment or facilities. These emissions are unanticipated and, as such, may not detected by typical monitoring and control devices. Aging assets going through many cycles, incorrect technology choice, and valve sizing, often escalate emissions. Government regulations, health and safety programs, and increasing public pressure are urging end users, valve manufacturers and suppliers, and process industry operators/contractors to reduce emissions.

Rotary valves, such as butterfly valves and ball valves, are a common type of valve used in process control systems. A rotary valve typically includes a valve body that defines a fluid passageway and a flow control member that is rotatable in the fluid passage to allow or block fluid flow. The flow control member is rotated by a shaft that extends through a channel defined the valve body. The rotary valve includes valve packing in the channel to help limit fluid leakage out of the channel. The valve packing is intended to provide a fluid tight seal between the valve shaft and the inner surface of the channel, while still enabling the valve shaft to easily rotate. While valve packing technology has improved in recent years, it can be difficult to completely prevent all fluid leakage across the valve packing. As such, a small amount of emissions, referred to as fugitive emissions, may still occur across the valve packing in rotary valves.

Disclosed herein are example control valve systems and apparatus that include mounting housings for use with rotary valves that can achieve zero fugitive emissions. An example control valve system disclosed herein includes a rotary valve, a linear actuator, and a mounting housing. The mounting housing is coupled between the rotary valve and the actuator. The rotary valve has a valve shaft that extends through a shaft channel that contains a valve packing. The valve shaft of the rotary valve extends into the mounting housing. Further, a push rod of the actuator extends into the housing. The control valve system includes a linkage (e.g., a lever) in the mounting housing that converts linear motion of the actuator rod to rotary motion of the valve shaft. The mounting housing is coupled to the valve body in a fluid tight manner. Therefore, any fugitive emissions that leak through the valve packing flow into the mounting housing. The control valve system includes a bellows seal around the actuator rod in the mounting housing. One end of the bellows is sealingly coupled (e.g., welded) to the rod, and the other end of the bellows is sealingly coupled (e.g., welded) to the inside of the mounting housing. The bellows prevents any fluid (e.g., fugitive emissions) in the mounting housing from leaking at the interface between the mounting housing and the actuator. Therefore, any fugitive emission that are leaked from the rotary valve are accumulated in the mounting housing, which is sealed (e.g., airtight). As such, the examples disclosed herein can achieve zero fugitive emissions in connection with a rotary valve.

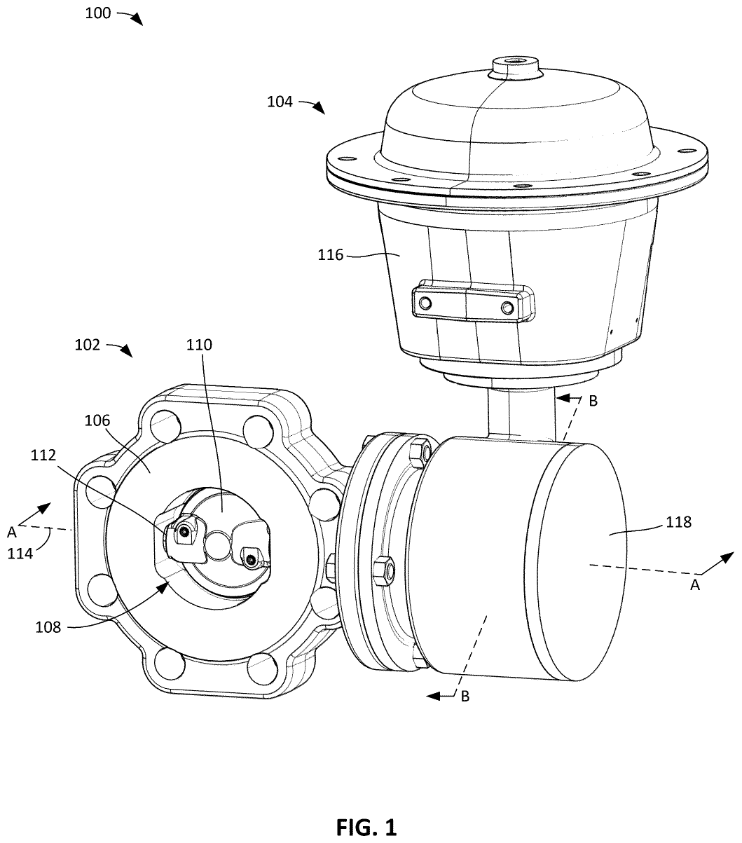

Now referring to the figures, FIG. 1 illustrates an example system or apparatus, referred to herein as a control valve system 100, constructed in accordance with the teachings of this disclosure. The control valve system 100 includes an example rotary valve 102 and an example actuator 104 for operating (e.g., opening or closing) the rotary valve 102. The example control valve system 100 may also be referred to as a control valve assembly or actuator valve assembly.

In the illustrated example, the rotary valve 102 includes a valve body 106 defining a fluid passageway 108 and a flow control member 110 disposed in the fluid passageway 108 of the valve body 106. The valve body 106 can be coupled between upstream and downstream pipes to control the flow of a fluid between the pipes. The flow control member 110 is rotatable in the fluid passageway 108 between a closed position, which is shown in FIG. 1, and an open position. In this example, the flow control member 110 is implemented as a disc. However, in other examples, the flow control member 110 can be implemented by another type of rotatable flow control member such as a ball. In the closed position, as shown in FIG. 1, the flow control member 110 blocks the fluid passageway 108, thereby preventing fluid flow between the pipes. The flow control member 110 can be rotated to an open position, in which the flow control member 110 is at least partially angled relative to the valve body 106, which allows fluid to flow through the fluid passageway 108 and, thus, between the pipes.

The rotary valve 102 includes a valve shaft 112 that is coupled to the flow control member 110. The valve shaft 112 is rotatable about a rotational axis 114. The valve shaft 112 can be rotated, about the rotational axis 114, to rotate the flow control member 110 between the open and closed positions. In some examples, the flow control member 110 is rotatable about 90° between the fully closed position, shown in FIG. 1, and a fully open position in which the flow control member 110 is substantially parallel to the fluid passageway 108. The flow control member 110 can also be rotated to any position or angle between the fully closed position and the fully open position to allow partial fluid flow.

In this example, the actuator 104 is a linear actuator. The actuator 104 includes a rod (shown in further detail herein) that is moved linearly (e.g., up-and-down in the orientation shown in FIG. 1) to control the rotary valve 102. The actuator 104 has an actuator casing 116 that houses a diaphragm and other components for moving the rod. The control valve system 100 has a linkage that converts linear motion of the rod to rotary motion of the valve shaft 112, as disclosed in further detail herein.

In the illustrated example, the control valve system 100 includes an example mounting housing 118 that is coupled between the rotary valve 102 and the actuator 104. In particular, the mounting housing 118 is coupled to the valve body 106 and to the actuator casing 116. As such, in this example, the mounting housing 118 couples the rotary valve 102 and the actuator 104. The mounting housing 118 is a sealed housing or chamber that is used to contain fugitive emissions, as disclosed in further detail herein. In some examples, the mounting housing 118 is constructed of metal, such as aluminum or stainless steel. The mounting housing 118 contains a linkage that converts linear motion of the rod to rotary motion of the valve shaft 112, as disclosed

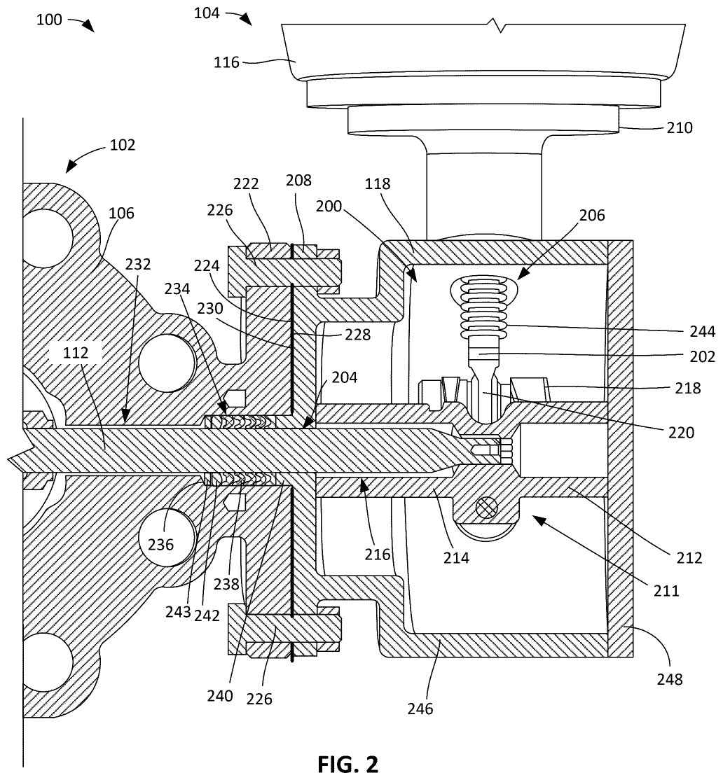

FIG. 2 is a cross-sectional view of a portion of the control valve system 100 taken along line A-A of FIG. 1. As shown in FIG. 2, the mounting housing 118 defines an interior region or chamber 200. In the illustrated example, the actuator 104 includes a rod 202. The actuator 104 can be activated to move the rod 202 in a linear direction (e.g., up-or-down in the orientation in FIG. 2, axially, etc.). The valve shaft 112 and the rod 202 extend into the interior region 200 of the mounting housing 118. In particular, the mounting housing 118 has a first opening 204 and a second opening 206. In the illustrated example, the mounting housing 118 has a first flange portion 208 that defines the first opening 204 and is coupled to the valve body 106, and includes a second flange portion 210 that defines the second opening 206 and is coupled to the actuator casing 116. The valve shaft 112 extends through the first opening 204 and into the interior region 200 of the mounting housing 118. Similarly, the rod 202 extends through the second opening 206 and into the interior region 200 of the mounting housing.

In the illustrated example, the control valve system 100 includes a linkage 211 that converts linear motion of the rod 202 to rotary motion of the valve shaft 112. The linkage 211 is disposed in the interior region 200 of the mounting housing 118 and is coupled between the valve shaft 112 and the rod 202. In this example, the linkage 211 is implemented as a lever 212. The lever 212 has a shaft portion 214 with a central channel 216. The valve shaft 112 extends into the central channel 216 of the shaft portion 214. The valve shaft 112 and the shaft portion 214 are rotationally fixed by a splined interface. For example, an outer surface of the valve shaft 112 has first splines that are engaged with second splines on the inner surface of the shaft portion 214. As such, rotation of the shaft portion 214 causes rotation of the valve shaft 112. In other examples, the valve shaft 112 and the shaft portion 214 can be coupled via other techniques, such as a keyed-shaped interface (e.g., polygonal cross-sections), welding, threaded fasteners, etc.

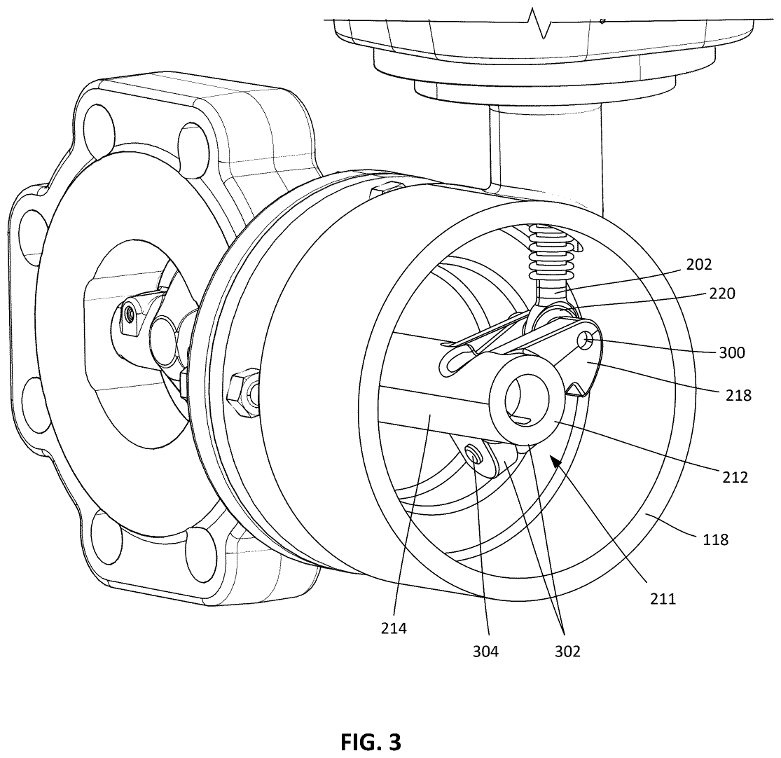

In the illustrated example, the lever 212 also includes a yoke 218 coupled to and extending from the shaft portion 214. In some examples, the shaft portion 214 and the yoke 218 are constructed as a single unitary part or component (e.g., a monolithic structure), but in other examples can be constructed as two separate parts that are coupled together. In the illustrated example, the rod 202 has a rod end 220 (e.g., a spherical rod end) that is coupled to the yoke 218. FIG. 3 is a perspective view of the inside of the mounting housing 118 showing the rod end 220 coupled to the yoke 218. In some examples, the rod end 220 and the yoke 218 are coupled by a pin or bolt 300. In the illustrated example, the shaft portion 214 has tabs 302 that can be tightened together (e.g., via a bolt or screw) to tighten/clamp the shaft portion 214 onto the valve shaft 112 (FIG. 2). When the rod 202 moves linearly (e.g., up-or-down), this movement cause the lever 212 to rotate, thereby causing rotation of the valve shaft 112 (FIG. 2). In some examples, the rod 202 is only moveable a relatively small distance (e.g., one or two inches) that causes the valve shaft 112 to rotate about 90°, which corresponds to the fully open and fully closed positions. However, in other examples, the rod 202 may be moveable a larger distance to rotate the valve shaft 112 greater than 90°.

In this example, the linkage 211, which converts linear motion to rotary motion, is disposed in the mounting housing 118 rather than in the actuator 104. This reduces complexity of the system compared to known actuator designs that have an incorporated linkage mechanism. In the illustrated example, the rod 202 and the valve shaft 112 (FIG. 2) are perpendicular to and offset from each other, but in other examples can be arranged in other configurations. Further, while in this example the linkage 211 is implemented as the lever 212, in other examples, the linkage 211 can be implemented by another type of linkage that can convert linear motion to rotary motion, such as a rack-and-pinion.

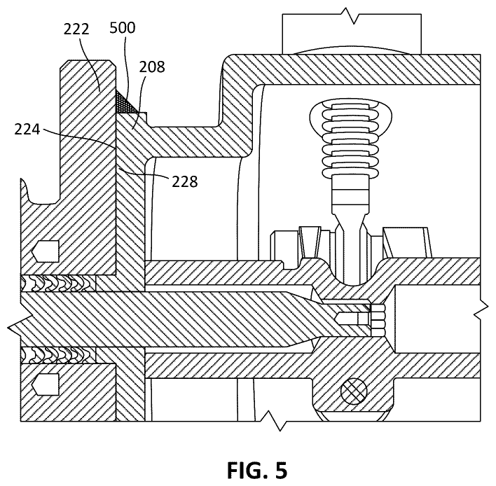

Referring back to FIG. 2, the valve body 106 has a flange portion 222 with a mounting surface 224. The first flange portion 208 of the mounting housing 118 is coupled to the flange portion 222 of the valve body 106. In the illustrated example, the first flange portion 208 of the mounting housing 118 and the flange portion 222 of the valve body 106 are coupled by one or more threaded fasteners 226, such as bults and nuts. In some examples, at least four threaded fasteners 226 are used, but in other examples can use more or fewer threaded fasteners 226. The first flange portion 208 of the mounting housing 118 has a mounting surface 228. The flange portions 208, 222 are coupled tightly to ensure no fluid leakage between the mounting surfaces 224, 228. For example, the threaded fasteners 226 can be torqued relatively tight to ensure a fluid tight seal between the mounting surfaces 224, 228. In some examples, a gasket 230 is disposed between the mounting surface 228 of the first flange portion 208 and the mounting surface 224 of the flange portion 222 to ensure a fluid tight seal between the mounting surfaces 224, 228. However, in other examples, a gasket may not be used and the mounting surfaces 224, 228 may instead be in direct contact with each other and/or coated with a sealant. In other examples, the flange portions 208, 222 can be coupled via other techniques. For example, referring to FIG. 5, the flange portions 208, 222 can be welded together. In the illustrated example, a weld bead 500 is formed between the mounting surface 224 and the outer radial edge of the first flange portion 208. The welding ensures a flight tight seal between the flange portions 208, 222.

Referring back to FIG. 2, the valve body 106 defines a shaft channel 232, which extends between the fluid passageway 108 (FIG. 1) and the mounting surface 224. The valve shaft 112 is disposed in and extends through the shaft channel 232. The valve shaft 112 is rotatable in the shaft channel 232. The valve shaft 112 extends through the shaft channel 232, and through the first opening 204 of the mounting housing 118 and into the interior region 200 of the mounting housing 118. In the illustrated example, the shaft channel 232 has an enlarged portion 234 (e.g., a counter-bore) between the mounting surface 224 and a shoulder 236 in the shaft channel 232. The control valve system 100 includes packing 238 disposed in the enlarged portion 234. The packing 238 encircles or surrounds the valve shaft 112. The packing 238 forms a low-friction, substantially fluid tight seal between the shaft channel 232 and the valve shaft 112 to limit or reduce fluid from leaking through the shaft channel 232. The packing 238 can include one or more seals (e.g., a stack of seals), which are composed of one or more materials that form a fluid seal between the valve shaft 112 and an inner surface of the shaft channel 232, while still enabling the valve shaft 112 to rotate smoothly in the shaft channel 232. Examples of materials that can be used include polytetrafluoroethylene (PTFE), graphite, duplex configurations, which include a combination of PTFE and graphite, or Ultra High Molecular Weight Polyethylene (UHMWPE). In some examples, the packing 238 includes one or more spacers (e.g., metal spacers).

In some examples, the control valve system 100 includes a wave spring 242 in the enlarged portion 234 to the shaft channel 232. The wave spring 238 is used to establish and maintain a controlled packing load and stress, such that the sealing performance can be maintained even if there is packing loss due to wear, temperature changes, etc. For example, the packing 238 may expand or contract due to temperatures changes (e.g., external atmospheric temperatures, internal fluid temperatures, etc.). Therefore, the wave spring 242 compresses or expands to allow the packing 238 to fluctuate and maintain a relatively constant packing load. In some examples, the mounting housing 118 is constructed of lower strength material, so the wave spring 238 helps to control fluid leakage from the valve body 106 to the mounting housing 118. In the illustrated example, the wave spring 242 is disposed between the packing 238 and a packing box ring 243 that is engaged with the shoulder 236, but in other examples can be disposed on the other side of the packing 238.

As shown in FIG. 2, the mounting housing 118 has an extension portion 240 that extends partially into the enlarged portion 234 of shaft channel 232. The packing 238, the wave spring 242, and the packing box ring 243 are clamped or axially compressed between the extension portion 240 and the shoulder 236 in the shaft channel 232. When the mounting housing 118 is initially coupled to the valve body 106, the threaded fasteners 226 can be torqued so that the extension portion 240 provides a certain axial load (e.g., pressure) on the packing 238. Therefore, in this example, the mounting housing 118 acts as a yoke for coupling the actuator 104 to the rotary valve 102 and as a packing follower for applying packing load. Generally, increasing the axial load on the packing 238 causes the packing 238 to expand radially and form a tighter fluid seal between the valve shaft 112 and the inner surface of the shaft channel 232. However, increasing the axial load also increases friction on the valve shaft 112, which can negatively affect the ability of the valve shaft 12 to rotate. Therefore, the packing 238 can be loaded to a certain point to form a substantially fluid tight seal that limits emissions, but still allows the valve shaft 112 to rotate smoothly.

However, even with efficient packing load and sealing material, a small amount of fluid may leak past the packing 238 and through the shaft channel 232. This fluid leakage is often referred to as fugitive emissions. As disclosed above, the first flange portion 208 of the mounting housing 118 is sealingly coupled to the flange portion 222 of the valve body 106 such that any emissions from the shaft channel 232 are leaked into and contained in the mounting housing 118. In general, no leakage typically occurs along the mounting surfaces 224, 228 because of their static sealing. However, fugitive emissions may occur through the shaft channel 232 because of dynamic sealing. In particular, any fugitive emissions that leak past the packing 238 will flow through the first opening 204 and into the interior region 200 of the mounting housing 118. As such, the fugitive emissions are contained or captured within the mounting housing 118 and, thus, do not leak into the atmosphere.

As described above, the mounting housing 118 is also coupled to the actuator casing 116. To prevent any emissions leakage at the interface of the mounting housing 118 and the actuator casing 116, the example control valve system 100 includes an example bellows 244. The bellows 244 is disposed around a portion of the rod 202 in the mounting housing 118. As disclosed in further detail herein, the bellows 244 is coupled to the rod 202 and to the mounting housing 118 and creates a fluid seal that prevents fugitive emissions out of the second opening 206 of the mounting housing 118. The bellows 244 is a cylindrical member having a plurality of folds, pleats, and/or convolutions. The bellows 244 can expand and contract while the rod 202 moves up-and-down.

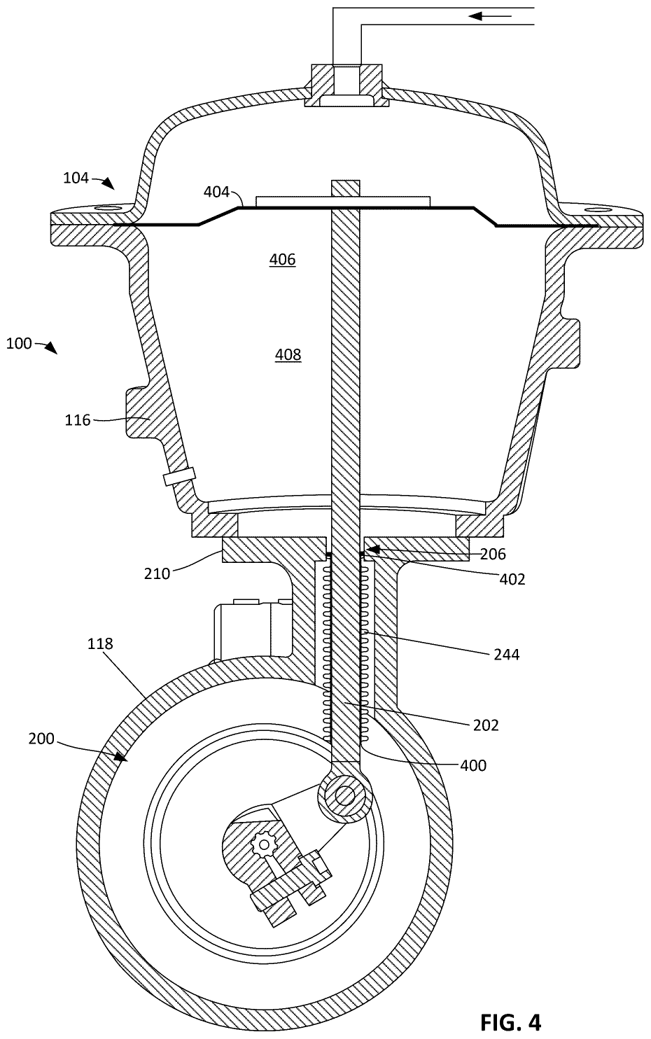

FIG. 4 is a cross-sectional view of the control valve system 100 taken along line B-B of FIG. 1. As shown in FIG. 4, the actuator casing 116 is coupled to the second flange portion 210 of the mounting housing 118. The rod 202 of the actuator 104 extends through the second opening 206 in the second flange portion 210 and into the interior region 200 of the mounting housing 118.

The bellows 244 is disposed in the mounting housing 118 and surrounds a portion of the rod 202 in the mounting housing 118. The bellows 244 has a first end 400 and a second end 402 opposite the first end 400. The first end 400 is fixedly and sealingly coupled to the rod 202, and the second end 402 is fixedly and sealingly coupled to the mounting housing 118. For example, the bellows 244 may be constructed of metal, such as a nickel-chromium alloy (e.g., N06625 or N06022 INCONEL®). The first end 400 of the bellows 244 is welded to the rod 202, near the bottom end of the rod 202, and the second end 402 of the bellows 244 is welded to the mounting housing 118. In this example, the second end 402 is welded to an inner surface of the second opening 206 at the second flange portion 210, but in other examples can be welded to another portion of the mounting housing 118. As such, the first and second ends 400, 402 of the bellows 244 are fluidly sealed. This ensures that no emissions can leak out of the second opening 206, or through the bellows 244. As such, any fugitive emissions that are leaked into the mounting housing 118 from the rotary valve 102 remain in the mounting housing 118 and cannot leak to the outside environment. Further, because it is anticipated that leakage can occur past the packing 238, the clearance and packing requirements can be relaxed. For example, the packing 238 can be implemented by simpler or less expensive seals, such as o-rings or sealed bearings.

In other examples, the bellows 244 can be constructed of other materials, such as rubber, and/or sealingly coupled to the rod 202 and the mounting housing 118 via other techniques.

As shown in FIG. 4, the actuator casing 116 is coupled to the second flange portion 210 of the mounting housing 118. In some examples, the actuator casing 116 and the second flange portion 210 may be coupled by threaded fasteners (e.g., bolts, screws). Because the bellows 244 is coupled to the mounting housing 118 and therefore prevents fluid leaking out of the second opening 206, the interface between the actuator casing 116 and the mountain housing 118 does not need to be a fluid tight interface. This relaxes the coupling requirements between the actuator casing 116 and the mounting housing 118.

The bellows 244 has a relaxed state. If the bellows 244 is expanded or contracted from the relaxed state, the bellows 244 naturally produces a return force back to the relaxed state, similar to a spring. Therefore, in some examples, this return force can be used to produce a return force on the rod 202 and eliminates the need for a return spring in the actuator 104. For example, as shown in FIG. 4, the rod 202 is coupled to a diaphragm 404 in the casing 116. The diaphragm 404 is flexible and divides the interior of the actuator casing 116 into two chambers 406, 408. In some examples, the lower chamber 408 is vented to atmosphere, whereas the upper chamber 406 is a sealed pressure chamber. To activate the actuator 104, a high pressure fluid (e.g., compressed air, fluid from the upstream or downstream pipes connected to the rotary valve 102 (FIG. 1), etc.) is supplied into the upper chamber 406. As a result, the diaphragm 404 moves downward (in the orientation of FIG. 4), which pushes the rod 202 downward and thereby rotates the flow control member 110 (FIG. 1) to the open position. This movement downward cause the bellows 244 to expand or lengthen. To move the flow control member 110 back to the closed position, the pressure in the upper chamber 406 is released or vented, which equalizes the pressure across the diaphragm. The bellows 244 provides an upward biasing that moves the rod 202 and the diaphragm 404 back upward to the original position. As such, in some examples, the actuator 104 does not include or require a return spring because the bellows 244 provides the return biasing force. This eliminates the need for additional components and thereby reduces costs and complexity associated with the control valve system 100.

Referring back to FIG. 2, the mounting housing 118 may be constructed of one or more parts or sections (e.g., walls, plates, etc.). The mounting housing 118 is constructed to be fluidly sealed (besides the first and second openings 204, 206) to ensure no fluid leaks from the mounting housing 118. In some examples, as shown in FIG. 2, the mounting housing 118 includes a first body portion 246 and a second body portion 248 that are sealingly coupled and define the interior region 200. In this example, the first body portion 246 is shaped like an open-top container and includes the first and second flange portions 208, 210. The second body portion 248 is a plate or wall and sealingly coupled to the first body portion 246 to prevent any leakage therebetween. For example, the first and second body portions 246, 248 can be welded together. In another example, the first and second body portions 246, 248 can be coupled via threaded fasteners. In other examples, the mounting housing 118 can be constructed of more than two body portions that are coupled together. In other examples, the mounting housing 118 can be constructed as a single part or component (e.g., a monolithic structure). In some examples, if the packing 238 is relatively effective, the lower pressure in the mounting housing 118 enables the bellows 244 and the mounting housing 118 to be constructed of weaker materials (e.g., lighter or less expensive materials).

In some examples, after a period of time, a certain amount of fugitive emission may be collected in the mounting housing 118. A person or machine can occasionally empty or evacuate the emissions from the mounting housing 118. For example, the control valve system 100 may include a pressure relief valve mounted on the mounting housing 118. The pressure relief valve may automatically open when a certain pressure is reached inside the mounting housing 118. In some examples, the emissions are vented to a treatment system or other desired collection area.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

From the foregoing, it will be appreciated that example systems, apparatus, and articles of manufacture have been disclosed for preventing fugitive emissions from a rotary valve. The examples disclosed herein can be used to achieve zero fugitive emissions. As such, the examples disclosed herein prevent the release of potentially dangerous fluids into the atmosphere.

Examples and combinations of examples disclosed herein include the following:

Example 1 is an apparatus comprising: a rotary valve including a valve body defining a fluid passageway, a flow control member in the fluid passageway, and a valve shaft coupled to the flow control member, the valve shaft extending through a shaft channel defined in the valve body; an actuator including a rod that is movable in a linear direction; a mounting housing coupled between the rotary valve and the actuator, the valve shaft extending into the mounting housing, the rod extending into the mounting housing; a linkage in the mounting housing coupled between the valve shaft and the rod, the linkage to convert linear motion of the rod to rotary motion of the valve shaft; and a bellows disposed around a portion of the rod in the mounting housing, the bellows coupled to the rod and the mounting housing to prevent fugitive emissions from the mounting housing.

Example 2 includes the apparatus of Example 1, wherein the bellows is constructed of metal.

Example 3 includes the apparatus of Examples 1 or 2, wherein the bellows has a first end and a second end opposite the first end, the first end welded to the rod, the second end welded to the mounting housing.

Example 4 includes the apparatus of any of Examples 1-3, wherein the actuator does not include a return spring.

Example 5 includes the apparatus of any of Examples 1-4, wherein the shaft channel has an enlarged portion between a mounting surface of the mounting housing and a shoulder in the shaft channel, the apparatus further includes packing in the enlarged portion of the shaft channel to form a seal between the valve shaft and the valve body.

Example 6 includes the apparatus of Example 5, further including a wave spring in the enlarged portion of the shaft channel.

Example 7 includes the apparatus of Examples 5 or 6, wherein the mounting housing has an extension portion extending partially into the enlarged portion of the shaft channel, and wherein the packing is axially compressed between the extension portion and the shoulder in the shaft channel.

Example 8 includes the apparatus of any of Examples 1-7, wherein the mounting housing has a first flange portion with a first opening and a second flange portion with a second opening, the first flange portion coupled to the valve body, the second flange portion coupled to a casing of the actuator.

Example 9 includes the apparatus of Example 8, wherein the first flange portion is sealingly coupled to a flange portion of the valve body such that any emissions from the shaft channel are leaked into and contained in the mounting housing.

Example 10 includes the apparatus of Example 9, wherein the first flange portion of the mounting housing is coupled to the flange portion of the valve body via one or more threaded fasteners.

Example 11 includes the apparatus of Example 10, further including a gasket between the first flange portion of the mounting housing and the flange portion of the valve body.

Example 12 includes the apparatus of any of Examples 9-11, wherein the first flange portion of the mounting housing and the flange portion of the valve body are welded together.

Example 13 includes the apparatus of any of Examples 1-12, wherein the mounting housing includes a first body portion and a second body portion that are sealingly coupled and define an interior region of the mounting housing.

Example 14 includes the apparatus of any of Examples 1-13, wherein the linkage is a lever.

Example 15 includes the apparatus of Example 14, wherein the lever includes a shaft portion and a yoke coupled to the shaft portion, wherein the valve shaft and the shaft portion are rotationally fixed by a splined interface, and wherein the rod has a rod end that is coupled to the yoke.

Example 16 is an apparatus comprising: an actuator having a rod that is movable in a linear direction; a mounting housing having a first flange portion with a first opening and a second flange portion with a second opening, the first flange portion to be coupled to a rotary valve, the second flange portion coupled to the actuator with the rod of the actuator extending through the second opening and into the mounting housing; a linkage in the mounting housing, the rod coupled to the linkage, the linkage to convert linear motion of the rod to rotary motion of a valve shaft; and a bellows disposed around a portion of the rod in the mounting housing, a first end of the bellows coupled to the rod and a second end of the bellows coupled to the mounting housing to prevent fugitive emissions at an interface of the mounting housing and the actuator.

Example 17 includes the apparatus of Example 16, wherein the bellows is constructed of metal.

Example 18 includes the apparatus of Example 17, wherein the first end of the bellows is welded to the rod, and the second end of the bellows is welded to an inner surface of the second opening.

Example 19 includes the apparatus of any of Examples 16-18, wherein the first flange portion has a mounting surface to be sealingly coupled to a flange portion of the rotary valve.

Example 20 includes the apparatus of any of Examples 16-19, wherein the mounting housing includes a first body portion and a second body portion that are sealingly coupled and define an interior region of the mounting housing.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
a rotary valve including a valve body defining a fluid passageway, a flow control member in the fluid passageway, and a valve shaft coupled to the flow control member, the valve shaft extending through a shaft channel defined in the valve body;
an actuator including a rod that is movable in a linear direction;
a mounting housing coupled between the rotary valve and the actuator, the valve shaft extending into the mounting housing, the rod extending into the mounting housing;
a linkage in the mounting housing coupled between the valve shaft and the rod, the linkage to convert linear motion of the rod to rotary motion of the valve shaft; and
a bellows disposed around a portion of the rod in the mounting housing, the bellows coupled to the rod and the mounting housing to prevent fugitive emissions from the mounting housing.

2. The apparatus of claim 1, wherein the bellows is constructed of metal.

3. The apparatus of claim 1, wherein the bellows has a first end and a second end opposite the first end, the first end welded to the rod, the second end welded to the mounting housing.

4. The apparatus of claim 1, wherein the actuator does not include a return spring.

5. The apparatus of claim 1, wherein the shaft channel has an enlarged portion between a mounting surface of the mounting housing and a shoulder in the shaft channel, the apparatus further includes packing in the enlarged portion of the shaft channel to form a seal between the valve shaft and the valve body.

6. The apparatus of claim 5, further including a wave spring in the enlarged portion of the shaft channel.

7. The apparatus of claim 5, wherein the mounting housing has an extension portion extending partially into the enlarged portion of the shaft channel, and wherein the packing is axially compressed between the extension portion and the shoulder in the shaft channel.

8. The apparatus of claim 1, wherein the mounting housing has a first flange portion with a first opening and a second flange portion with a second opening, the first flange portion coupled to the valve body, the second flange portion coupled to a casing of the actuator.

9. The apparatus of claim 8, wherein the first flange portion is sealingly coupled to a flange portion of the valve body such that any emissions from the shaft channel are leaked into and contained in the mounting housing.

10. The apparatus of claim 9, wherein the first flange portion of the mounting housing is coupled to the flange portion of the valve body via one or more threaded fasteners.

11. The apparatus of claim 10, further including a gasket between the first flange portion of the mounting housing and the flange portion of the valve body.

12. The apparatus of claim 9, wherein the first flange portion of the mounting housing and the flange portion of the valve body are welded together.

13. The apparatus of claim 1, wherein the mounting housing includes a first body portion and a second body portion that are sealingly coupled and define an interior region of the mounting housing.

14. The apparatus of claim 1, wherein the linkage is a lever.

15. The apparatus of claim 14, wherein the lever includes a shaft portion and a yoke coupled to the shaft portion, wherein the valve shaft and the shaft portion are rotationally fixed by a splined interface, and wherein the rod has a rod end that is coupled to the yoke.

16. An apparatus comprising:
an actuator having a rod that is movable in a linear direction;
a mounting housing having a first flange portion with a first opening and a second flange portion with a second opening, the first flange portion to be coupled to a rotary valve, the second flange portion coupled to the actuator with the rod of the actuator extending through the second opening and into the mounting housing;
a linkage in the mounting housing, the rod coupled to the linkage, the linkage to convert linear motion of the rod to rotary motion of a valve shaft; and
a bellows disposed around a portion of the rod in the mounting housing, a first end of the bellows coupled to the rod and a second end of the bellows coupled to the mounting housing to prevent fugitive emissions at an interface of the mounting housing and the actuator.

17. The apparatus of claim 16, wherein the bellows is constructed of metal.

18. The apparatus of claim 17, wherein the first end of the bellows is welded to the rod, and the second end of the bellows is welded to an inner surface of the second opening.

19. The apparatus of claim 16, wherein the first flange portion has a mounting surface to be sealingly coupled to a flange portion of the rotary valve.

20. The apparatus of claim 16, wherein the mounting housing includes a first body portion and a second body portion that are sealingly coupled and define an interior region of the mounting housing.
